(19) United States
(12) Patent Application Publication
(10) Pub. No.: US 2014/0310591 A1
(43) Pub. Date: Oct. 16, 2014

(54) PRESENTATION LAYER SOFTWARE DEVELOPMENT KIT FOR CREATION OF DYNAMIC WEBPAGES

(71) Applicants: Thong Nguyen, St. Louis Park, MN (US); Jay Finch, St. Paul, MN (US); Erik Mason, Burnsville, MN (US); Erik Mitchell, Minneapolis, MN (US); Cory Roloff, Roseville, MN (US); Nathaniel Caza, Burnsville, MN (US); David Souza, Shakopee, MN (US); Ryan Schmidt, Shakopee, MN (US); Chrystine Twigg, Burnsville, MN (US); Sean Walker, Apple Valley, MN (US)

(72) Inventors: Thong Nguyen, St. Louis Park, MN (US); Jay Finch, St. Paul, MN (US); Erik Mason, Burnsville, MN (US); Erik Mitchell, Minneapolis, MN (US); Cory Roloff, Roseville, MN (US); Nathaniel Caza, Burnsville, MN (US); David Souza, Shakopee, MN (US); Ryan Schmidt, Shakopee, MN (US); Chrystine Twigg, Burnsville, MN (US); Sean Walker, Apple Valley, MN (US)

(21) Appl. No.: 14/209,824

(22) Filed: Mar. 13, 2014

Related U.S. Application Data
(60) Provisional application No. 61/780,049, filed on Mar. 13, 2013.

(51) Int. Cl. G06F 17/22

(52) U.S. Cl. CPC G06F 17/2247
USPC 715/234

(57) ABSTRACT

Systems and methods for designing and implementing dynamic and template-based web page content are described herein. One example includes a presentation layer software development kit providing a full-featured graphical user interface for the design of web page components and structures. The presentation layer software development kit may integrate with various design, development, compilation, and testing tools to generate production-ready web page output in a scalable architecture. Using the presentation layer software development kit, modifications to the web page content may be generated, tested, and deployed in a real-time basis, reducing design and implementation times.

### PRIORITY AND RELATED APPLICATIONS

This application claims the benefit of priority to U.S. Provisional Patent Application Ser. No. 61/780,049, filed Mar. 13, 2013, and includes subject matter common to U.S. patent application Ser. No. 14/205,147, filed Mar. 11, 2014, currently pending; both applications are incorporated by reference herein in their entireties.

### TECHNICAL FIELD

Embodiments pertain to techniques and systems for development of websites and internet-accessible graphical user interfaces. Some embodiments relate to software-based tools and architectures to design, develop, and implement dynamic and template-based web pages and content included within such web pages.

### BACKGROUND

A variety of tools are used to design and implement web pages to be hosted by web sites. Some of the most basic tools involve the design and generation of static HTML in a web page, with hard coded text and design elements programmed directly into the HTML. Other existing tools involve the design of web pages to include dynamic data, often utilizing specific server-side data calls or scripting to be added into the web page code during development. This often forces the web page developer to be proficient in both design and data access techniques.

In many scenarios, different development teams are involved with creation of a website, with one team focusing on the design elements of webpages (for example, user interface designers, graphic designers, and the like), versus another team focusing on the data elements used to serve the dynamic content in the webpages (for example, database programmers, server managers, and the like). Additionally, other parties such as quality assurance teams may wish to perform tests on the web page output to ensure accuracy and compliance in the final output website.

Changes to the layout of web pages often requires changes to the design, which may require rework to the data elements, which may require rework to the testing process, and so forth. Existing systems and techniques do not provide adequate mechanisms to segment the development of webpage design between HTML design elements and the back-end data, or provide useful tools to automate such processes.

### BRIEF DESCRIPTION OF THE DRAWINGS

FIG. 1A illustrates an architecture for the creation of dynamic web pages according to an example described herein.

FIG. 1B illustrates a set of operational layers of a presentation layer development environment according to an example described herein.

FIG. 1C illustrates component interactions used to generate artifacts of dynamic web pages with a presentation layer development environment according to an example described herein.

FIG. 2 illustrates an overview of a process to utilize a presentation layer development environment for the creation of dynamic web pages according to an example described herein.

FIG. 3A illustrates a first portion of a detailed process for generating a web page in a presentation layer development environment according to an example described herein.

FIG. 3B illustrates a second portion of a detailed process for generating a web page in a presentation layer development environment according to an example described herein.

FIG. 4 illustrates a deployment of a web page developed with a presentation layer development environment according to an example described herein.

FIG. 5 illustrates a generation and testing of an electronic commerce web page with a presentation layer development environment according to an example described herein.

FIG. 6 illustrates a graphical user interface of a presentation layer development environment providing a selection and modification of designed web pages according to an example described herein.

FIG. 7 illustrates a graphical user interface of a presentation layer development environment providing a selection and modification of a data scenario used in a web page according to an example described herein.

FIG. 8 illustrates a graphical user interface of a presentation layer development environment providing a compilation and testing of designed web pages according to an example described herein.

FIG. 9 illustrates a graphical user interface of a presentation layer development environment providing a compilation and testing of modular components for use in a designed web page according to an example described herein.

FIG. 10A illustrates a graphical user interface of a presentation layer development environment providing a selection of deployable web sites having designed web pages according to an example described herein.

FIG. 10B illustrates a graphical user interface of a presentation layer development environment providing a preview of a deployable web site having designed web pages according to an example described herein.

FIG. 11 illustrates an example method of generating a web page using a presentation layer development environment according to an example described herein.

FIG. 12 illustrates an example system configuration of a system arranged to provide and operate a presentation layer development environment according to an example described herein.

FIG. 13 illustrates an example of a computer system to implement techniques and system configurations according to an example described herein.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The present disclosure illustrates various techniques and configurations to enable the development of web pages and associated web sites within a development framework having a full-featured graphical user interface (GUI). This web page development framework, further referred to herein as a “presentation layer software development kit (SDK)” enables the creation of dynamic web pages with an enhanced user experience. Such web pages may be deployed in any number of settings, but in particular can provide a scalable architecture for large websites with frequently changing content (for example, in an e-commerce web site with thousands of changing products and product information).

The presentation layer SDK may integrate a number of development and testing processes to enable a user to immediately see what he or she is building, as the respective web page components (referred to as “modules”) are being built. Presentation layers for the web page modules may be built on top of data, but without requiring hard-coded references to such data. Such design methods enable web page modules in the presentation layers to be prototyped and moved into production in a rapid fashion. These mechanisms accordingly reduce the lifecycle needed to move web pages from development into production.

The presentation layer SDK enables the creation of various presentation layers in web page modules that can be added, replaced, swapped out, and copied elsewhere. The use of modular web page components with the presentation layer SDK offers a clean architectural separation to reuse components down the road, with less waste and rework. Further, the use of data references in the modules enables a designer to build the user experience for the particular modules, without needing to customize the data call to the uses of the modules.

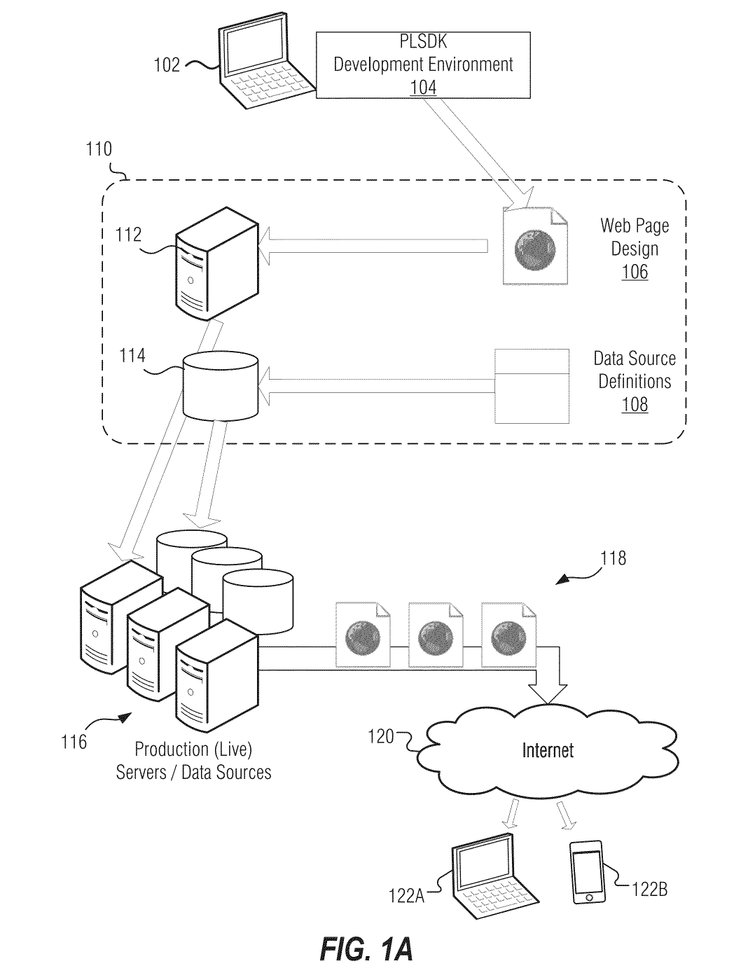

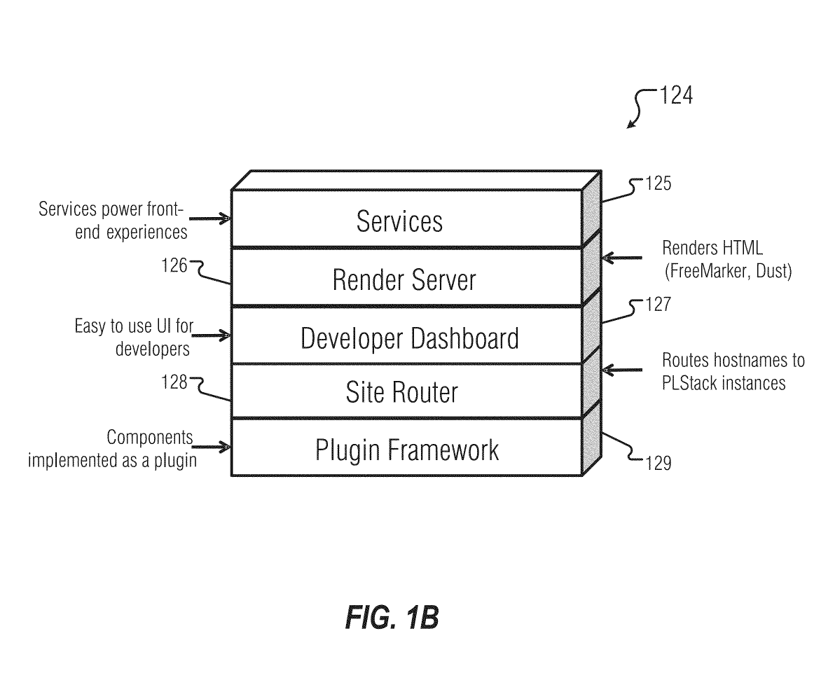

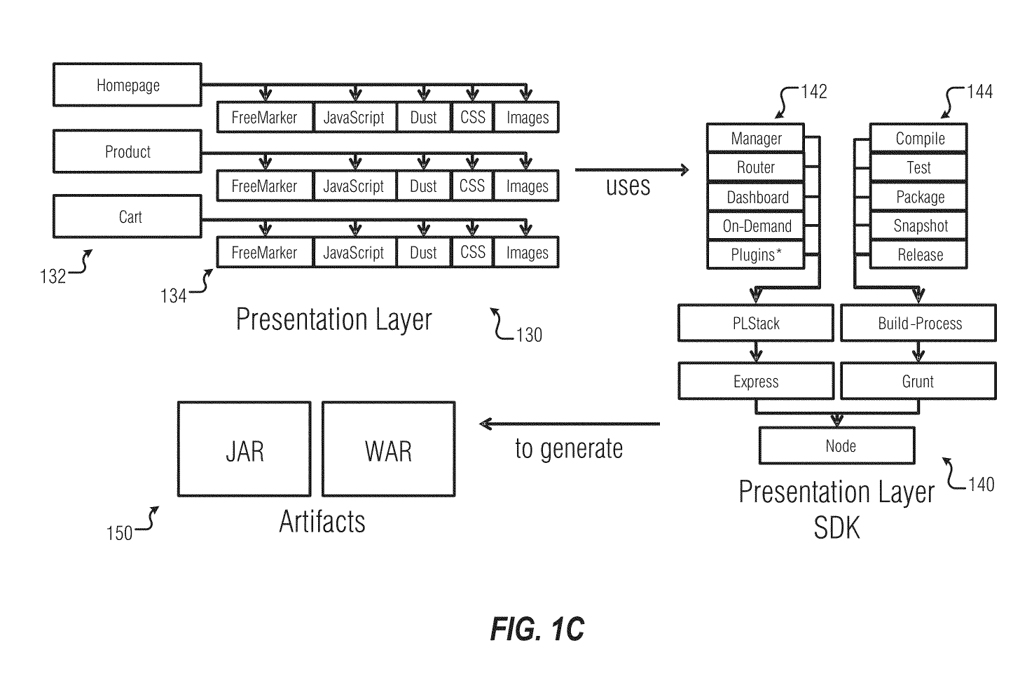

FIG. 1A illustrates an overview of development and deployment of a web page with use of the presentation layer SDK according to one example. As illustrated, a computing device 102 (e.g., a PC) is used to operate the presentation layer SDK development environment 104 (e.g., a GUI and associated software applications). The presentation layer SDK development environment 104 produces a web page design 106 for use in a prototype environment 110. The prototype environment may include a web page design 106 having web pages constructed from a variety of sub-components, for operation on a web server 112.

The web page design 106 is configured to reference various data inputs and values from a mock data source. These data values are referenced using a set of data source definitions 108. The prototype environment 110 may include a database or data object 114 (e.g., containing or referencing mock data) to provide sample testing data for access by the data source definitions 108.

Upon adequate design and testing of the web page design 106 and the data source definitions 108 in the prototype environment 110, a web page output is provided to a set of production web servers and data sources 116. This web page output can replace references to the mock data source with a production data source (e.g., the “live” website). The production web servers and data sources 116 will serve to output a series of web pages 118 for delivery to client devices 122A, 122B via the internet 120. Thus, the series of web pages 118 in combination serves to offer a fully functional web site serving dynamic content to browsing users.

FIG. 1B provides an illustration of various operational layers 124 offered through the components and framework of the presentation layer SDK. These include a services operational layer 125 (used to power the front-end user interface (UI) experiences of the webpage); a render server layer 126 (used to render HTML, CSS, JavaScript, and other resources of the webpage from templates on a web server with use of tools such as FreeMarker); a developer dashboard layer 127 (used to provide developers with an user interface to develop web page content and control operations of the UI development environment); a site router layer 128 (used to route hostnames to “PLStack” test stack instances and route AJAX calls to mocked out service APIs, e.g., to simulate the deployment of the website on a production server); and a plugin framework layer 129 (used to perform various development, functionality, and testing actions in the development environment with the use of modular plugins).

Within the operational layers 124, and in the operations of the presentation layer SDK development environment 104 and the prototype environment 110, a variety of design, mockup, testing, and compilation activities may occur. As another perspective of usage for the operational layers 124, FIG. 1C illustrates how content that is provided for individual site design projects can be defined and transformed. The content may be defined from a presentation layer 130, processed by operational components of the presentation layer SDK 140, and transformed into artifacts 150 (e.g., the artifacts that provide the respective elements of the web pages that are launched on the production servers and data sources 116).

The generation of the website content from a presentation layer 130 includes the creation of various presentation layer projects 132 (depicted in FIG. 1C as “homepage”, “product” and “cart” projects). The presentation layer projects 132 are each directed to different UI and functionality elements (for example, an individual product page in an e-commerce site, generated from the “product” project, offers a number of different elements than the checkout page, generated from the “checkout” project and used to commence the purchase of a set of selected items).

The different UI and functionality elements are represented by presentation components 134 for the respective presentation layer project, which may include: a FreeMarker template source (for use with a FreeMarker template project that uses regular HTML conventions, to render views in HTML content divs, as further discussed below), a JavaScript source, a Dust JavaScript template source (used for templating client-side changes with a JavaScript source that derives content from JSON scenario file), a CSS source, and an Images source. The presentation components 134 for the presentation layer projects 132 are then utilized and consumed by the elements of the Presentation Layer SDK 140. The Presentation Layer SDK 140 in turn transforms the various templates, development elements, and page definitions into the artifacts 150.

The Presentation Layer SDK 140 offers a suite of modularized UI engineering tools and technologies, through interoperating (and substitutable) components that can be utilized to modernize and streamline the development process. The interoperating and modular nature of the Presentation Layer SDK 140 and its consumed content allows teams to work on different elements of a web site (and individual web pages) in parallel, and provides a self-service operating model for modules of the webpage. A variety of plug-ins can be incorporated into the Presentation Layer SDK 140 to perform additional design, development, and testing functions. Accordingly, the Presentation Layer SDK 140 enables presentation elements and projects within complex websites to be rapidly designed, prototyped, tested, and deployed. These operations are accomplished in the Presentation Layer SDK 140 through the use of a stack of development elements 142 and a stack of deployment elements 144.

The stack of development elements 142 is depicted as including: a manager component to manage the elements, structure, and characteristics of a particular design project; a router component to route requests from a particular design project to an appropriate prototype or production location; a dashboard to provide a control interface for the design project; an on-demand component to generate and handle on-demand content for the design project; and plugins used to perform various actions (including design, testing, validation actions) on the design project. The output of the stack of development elements 142 produces a presentation layer stack (PLStack), which can then be processed by Express (a web application framework for Node.js), and ultimately Node.js (an event-driven, non-blocking I/O architecture built on Google's V8 JavaScript engine). Accordingly, the output of the stack of development elements can be used to design, prototype, test, and produce usable code for a particular web page or web page component.

The stack of deployment elements 144 is depicted as including: a compile component to compile the website code; a test component to test website code; a package component to package the website code; a snapshot component to generate a snapshot of the website code for analysis and processing; and a release component configured to generate a particular release version of the website code for deployment. The output of the stack of deployment elements is provided to a build process, which is then verified through Grunt (a JavaScript task runner, used as a build system to generate the output). Finally, the output of the verified and built output is provided for processing in connection with Node.js.

The output of the presentation layer SDK 140 is used to generate various artifacts 150, such as JAR artifacts (including front-end assets, such JS, CSS files) and WAR artifacts (including FreeMarker template files used for generating templated server-side HTML output) to produce the output of the web page design 106 and the data source definitions 108. These artifacts may then be deployed for use in prototype and deployment scenarios (e.g., at the prototype environment 110 and the production servers 116).

The presently described configuration and usage of the presentation layer SDK resolves three issues that repeatedly arise in the context of website development: the need to quickly and consistently change, build, and output front-end code; the need to check and enforce standards and code quality among different pages and projects of the web site; and the need to work in advance of underlying data and processing services being completed. Each of these requirements is satisfied through the modular testing and deployment structure established by the presentation layer SDK.

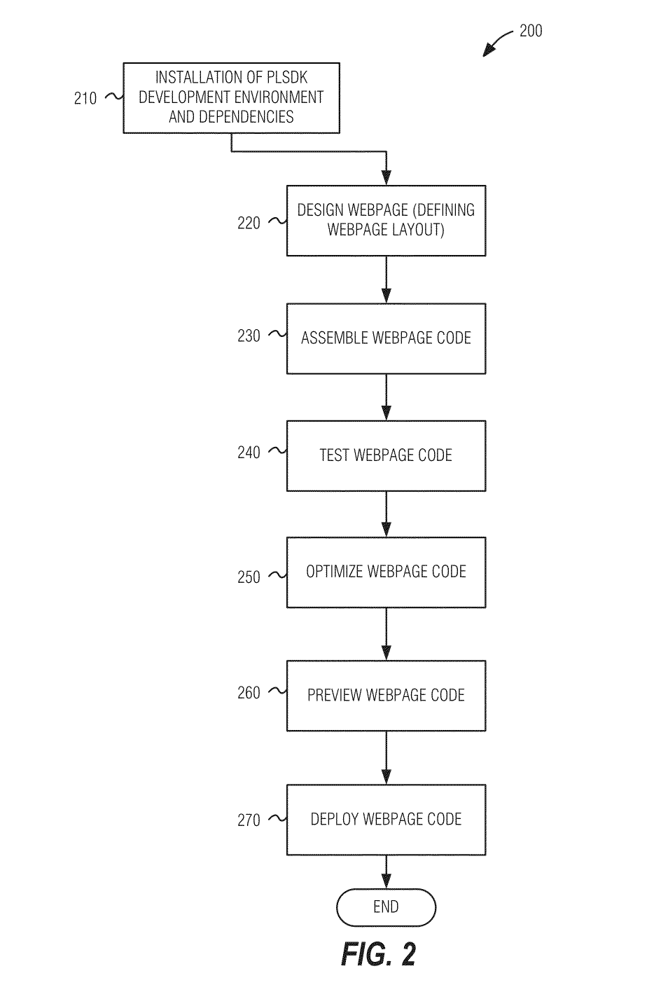

FIG. 2 depicts an overview of a process to utilize the presentation layer SDK for the creation of dynamic web pages such as the web pages 118 according to an example described herein. As shown, a sequence of operations 200 is commenced from the installation of the presentation layer SDK and associated dependencies and plugins (operation 210). The following sequence of operations provides an example of a web page development process resulting from the processing and execution of actions (including modules and plugin functions) in the presentation layer SDK, but it will be apparent that variations to the following order of operations may be conducted.

First, a web page design is established for defining the web page layout (operation 220). The web page design may be defined through GUI interactions, manual HTML coding and editing, or a combination thereof. Next, the presentation layer SDK is used to assemble web page code, such as HTML, CSS, JavaScript, other browser-renderable code (operation 230).

The presentation layer SDK may also provide mechanisms to enable a user to immediately test the web page code (operation 250) and optimize the web page code (operation 260). Finally, the web page code may be deployed on web site (operation 270) for serving to browser clients. For example, the web page code and associated static content such as images, scripts, and styles may be placed on one or more internet-accessible web page servers for hosting and access by remote users. Other server-side files, software, and configurations may be implemented by the presentation layer SDK as part of the deployment of the webpage code.

In further examples, where a content of a web page has been changed, the presentation layer SDK may be configured to generate, rebuild, recompile, or otherwise provide only the particular portion of the file(s) that have changed. The presentation layer SDK operates to detect which particular files or portions of the files are modified or are affected from the dependencies of the content. Accordingly, when a change is implemented, only the particular file or (portion of the file) that is affected may be re-compiled and changed. Thus, changes to the template files, JavaScript files, and style (CSS) files that are affected by the UI change may be minimized. Further, the presentation layer SDK may implement forms of on-demand compilation, so that as each webpage and its associated resource is requested and accessed in the development environment, a check is made to determine whether the underlying resource needs to be re-compiled or re-built (and performing the re-compilation or re-building of this resource, e.g., a JavaScript resource, in real time, where appropriate).

### Features of Presentation Layer SDK

The presentation layer SDK may provide a web-based GUI, executable on various platforms (e.g., Mac OS and Windows), to integrate with a series of development components including open source components. For example, the presentation layer SDK may integrate with a JavaScript runtime such as Node.js to design and serve data elements in the web page. The presentation layer SDK may also provide GUI controls to enable users to design and manipulate web page components without the use of manual coding. The presentation layer SDK can provide compilation of the web page components and component outputs during the design process, on demand or automatically as changes are made.

The presentation layer SDK enables the use of presentation layers separate from underlying data, including the creation of data element references without requiring hard-coded references to the data in the web page components. To accomplish this, the presentation layer SDK may include capabilities to test simulated data values and data references that can be defined at a later time. In addition, the presentation layer SDK includes routing capabilities to simulate server-side processing (such as AJAX requests) and thus fully render designed web page components. These routing capabilities may also include the use of a proxy tool, to intercept requests to a production server address and substitute a local/replacement copy of resources, such as templates, JS, CSS, and sample data.

The presentation layer SDK can perform integrated processing operations with third party applications to facilitate deployment and usage. For example, the presentation layer SDK may render a template file into HTML pages for preview capability, and render the template file against multiple JSON files to mock up server-side variations of data. Output JavaScript and style files may be converted, merged, and minified as appropriate. Other techniques such as MD5 fingerprinting or hashing may be applied to rename files for server-side output.

The presentation layer SDK may also enable the creation and use of a variety of site-specific templates as defaults for new pages and components. The organization and categorization of pages can be entirely customizable within the presentation layer SDK. The presentation layer SDK may be used to edit multiple web sites or web site scenarios, providing environments for both debug and release mode outputs. Output files and scripting, styles, and HTML output may also be analyzed, tested, and validated.

### Example Web Page Creation Process

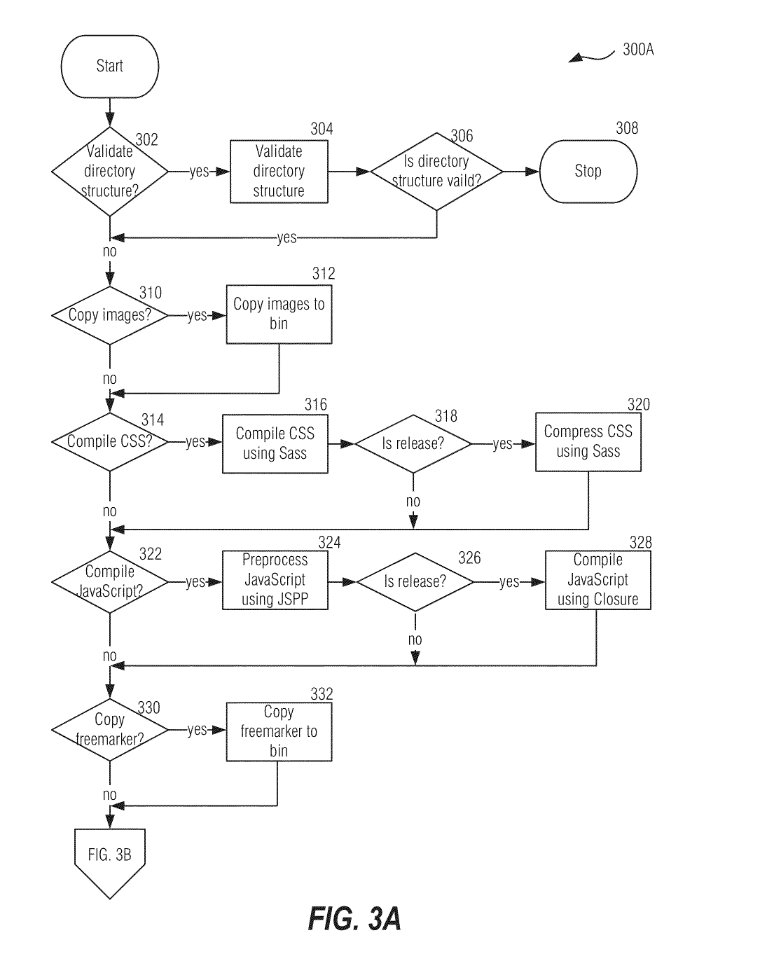

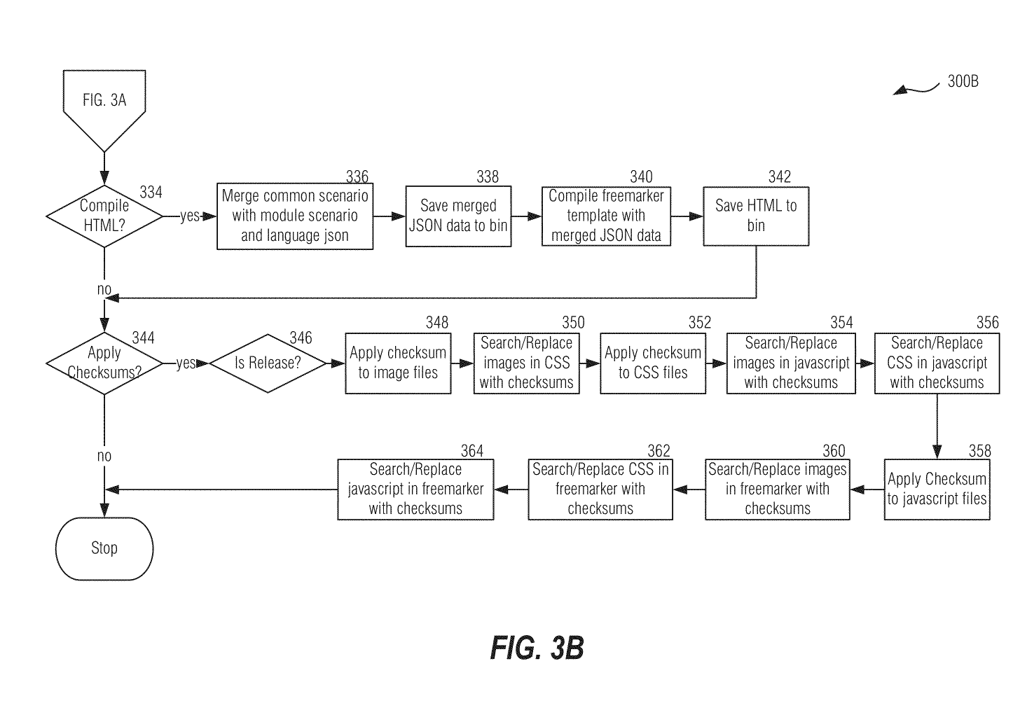

The presentation layer SDK may perform a multi-step verification and compilation when generating a web page and associated web page components. FIG. 3A illustrates a first portion of a detailed process 300A for generating a web page in a presentation layer development environment according to an example described herein.

As shown, the process 300A includes a series of operations performed in response to determining that a directory structure for a web site project is to be validated (decision 302). These operations include validating the directory structure (operation 304), and proceeding if the directory structure is valid (decision 306). If the directory structure is not valid, the process 300A terminates (operation 308).

Next, the process 300A includes an operation to copy images to a bin or other destination folder (operation 312) in response to determining that images are available to be copied (decision 310). These images and other associated files are placed in a destination folder for deployment on the web site.

Next, the process 300A includes operations to compile a cascading style sheet (CSS) file performed in response to determining that a CSS file is available to be compiled (decision 314). These operations include compiling the CSS file using Sass (operation 316). If the CSS file is designated for release (determined by decision 318), the CSS file for release is compressed using Sass (operation 320).

Next, the process 300A includes operations to compile a JavaScript file performed in response to determining that a JavaScript file is available to be compiled (decision 322). These operations include preprocessing the JavaScript file using the JSPP scripting language (operation 324). If the JavaScript file is designated for release (determined by decision 326), the JavaScript file for release is compressed using Closure (operation 328).

Next, the process 300A includes operations to copy a FreeMarker compilation in response to determining that a FreeMarker compilation file is available to be copied (decision 330). The FreeMarker compilation file provides a template-based form of the web page, used to deploy the design of the web site and associated Java objects into output (after running through the FreeMarker template engine). Other template-based compilations may also be used or substituted for the usage of FreeMarker.

The process 300B, illustrated on FIG. 3B, continues the series of operations. These include operations to compile HTML output performed in response to an instruction that the HTML output is available to be compiled (decision 334). The operations include merging a common scenario with a module scenario and language JSON (operation 336), saving the merged JSON data to the bin folder (operation 338), compiling a FreeMarker template with the merged JSON data (operation 340), and saving the HTML to the bin folder (operation 342).

Next, the process includes operations to apply checksums to the various files, to genericize and rename the file names, in response to determining that the files are available to have checksums applied (decision 344) and that the output is designated for release (decision 346). If the output is designated for release, further operations include applying the checksum to the image files (operation 348), search and replacing images in the CSS files with checksums (operation 350), applying the checksum to the CSS files (operation 352), searching and replacing imagines in the JavaScript files with checksums (operation 354), searching and replacing CSS in the JavaScript files with checksums (operation 356), applying checksum to the JavaScript files (operation 358), searching and replacing image references in the FreeMarker template file with checksums (operation 360), searching and replacing CSS references in the FreeMarker template file with checksums (operation 362), and searching and replacing JavaScript references in the FreeMarker template with checksums (operation 364).

### Example Web Page Creation and Generation Process

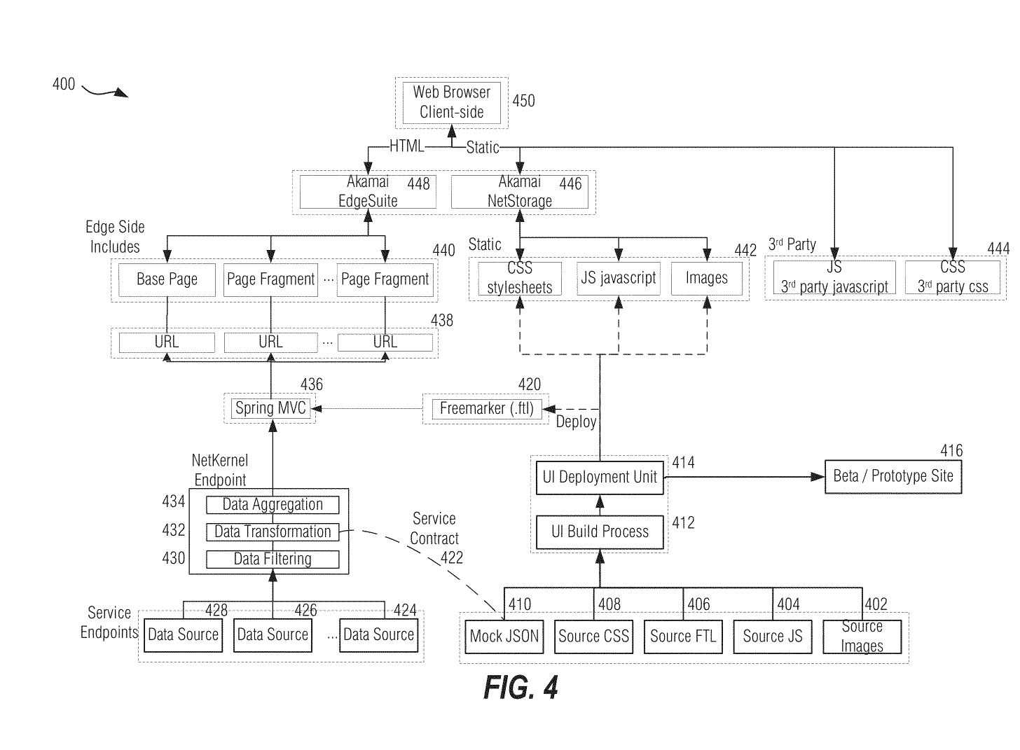

FIG. 4 provides an overview of server-side data operations 400 for delivering a web page output to a client-side user, such as at a web browser 450. Operations involving the presentation layer SDK are utilized during the user interface build process 412 and with a user interface deployment unit 414. The input to the user interface build process 412, compiled by the presentation layer SDK, includes one or more source images 402, one or more source JavaScript files 404, one or more source FreeMarker .FTL template files 406, one or more source CSS files 408, and one or more mock JSON files 410. The presentation layer SDK utilizes the user interface deployment unit 414 to generate a beta or prototype site 416. (This beta or prototype site can be used for a variety of mockup, testing, and development operations). In other examples, the prototype site may be launched or simulated directly within use of the presentation layer SDK (such as by routing and proxying techniques launched from the presentation layer SDK to simulate a deployment on a server with intercepted requests obtaining sample data).

The output of the presentation layer SDK is used to provide a rendering template 420, for example, in the FreeMarker .FTL format. This is provided to a Spring Web model-view-controller (Spring MVC) 436 application to produce HTML output. The HTML output provides a correct integration of the data values produced from production data sources.

The data values are established from various data sources 424, 426, 428, through data filtering 430, data transformation 432, and data aggregation 434 operations. The data is referenced through use of a data service contract 422 between the mock JSON files 410 and the data sources. This data service contract is used to define and establish a common schema for the particular data fields that are used in the respective templates. For example, the mock JSON will designate references to data values that are used at different locations in the web page components. A database developer may take these references to produce values from the production data sources. Thus, the mock JSON data is used because the actual data calls from the production databases are not established until runtime.

The output from the Spring MVC 436 is to create various components at respective URLs 438 which make up modules for inclusion at the server, including a base page and page fragments 440. The base page and page fragments at this point include the HTML output with integrated data values, essentially the HTML output for serving by the web server. Accordingly, this HTML output is served by a web server 448. (This web server may be offered as part of a cloud service or content network, for example, with the use of a large-scale site that offloads server requests through the use of a content delivery network such as Akamai or Amazon).

The other elements of the webpage, including CSS files, JavaScript files, and images 442, designated from an output of the user interface deployment unit 414, are also provided from a web server 446.

Thus, the web browser 450 is provided with content from a variety of sources: the HTML content from web server 448, graphical/scripting/design files from web server 446, and third party content such as third party JavaScript and CSS files from other web servers 444.

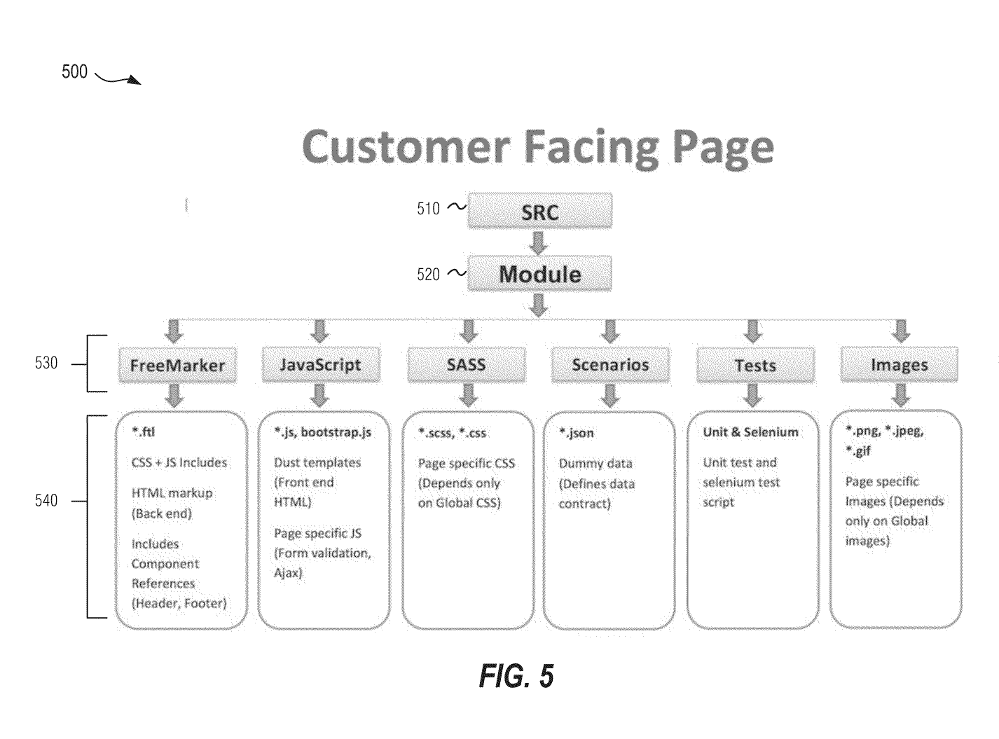

FIG. 5 illustrates a development hierarchy 500 providing another example of the generation of a design and webpage components for a customer-facing page, originating from the operation of the presentation layer SDK and its components. As shown, the creation of HTML, JavaScript, CSS, and other output source code 510 is generated from use of a module 520 (and in certain scenarios, sets of modules) that operates to define the characteristics of the web page output. The module 520 is used to model a substitutable or replaceable element of the web page, and provide some detailed functionality for the output of information in the web page.

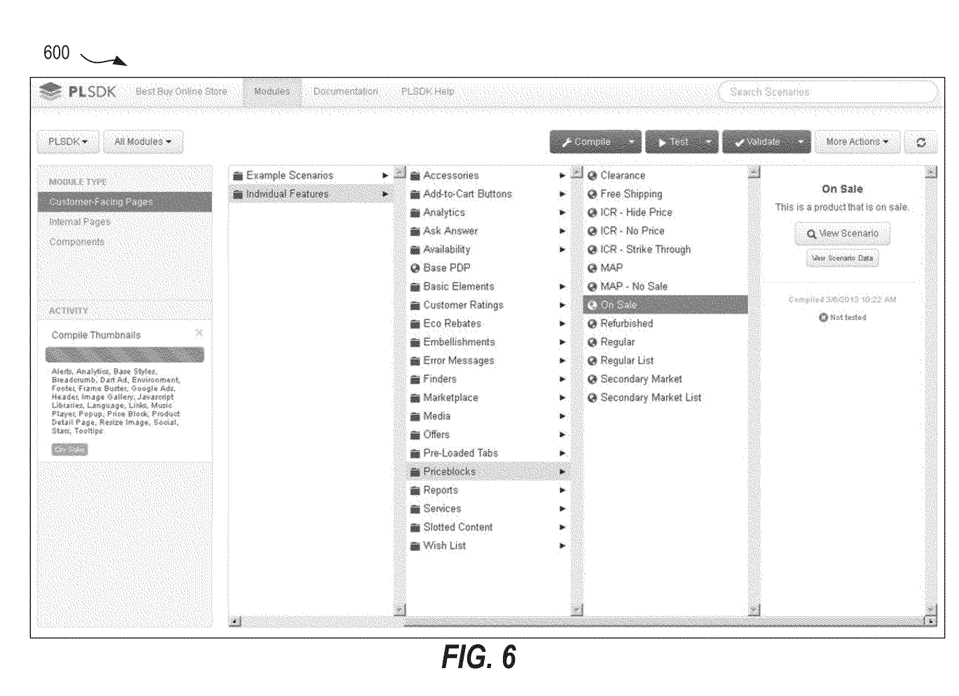

A particular module such as a “product reviews” module may be included for generation of a product review section of a particular product sold on an e-commerce website; a “related products” module may be included for generation a related products section of a particular product sold on an e-commerce website; and the like. Accordingly, a full-featured website may be specified from hundreds or thousands of defined modules which provide different displays and functions for webpage output. (An example of a hierarchy of modules providing individual features of an e-commerce website is illustrated in FIG. 6).

The design and webpage components generated for the module 520 used in the customer facing page may include the operation of variety of functional components 530 established from respective functional component files 540. These may include use of components including:

FreeMarker functional component, used to process FreeMarker template code (e.g., .ftl files), including CSS+JS includes and HTML markup code that uses regular HTML conventions. FreeMarker operates to render views in content divs, and call JSON data directly into FreeMarker template files. The FreeMarker template files are used in connection with templates that are rendered on the server side (e.g., generating standard HTML output that is sent to the browser).

JavaScript component, used to process generated JavaScript code. For some pages, there is an initial server-side rendering, but then later there is significant user interaction with the page (e.g., via AJAX calls, in functionality such as the shopping cart, with customers adding/removing items, changing quantity, and the like). On such pages, a Dust template may be rendered client-side, in the user's browser. The Dust template allows updating of the page using just the JSON data returned from the AJAX calls, as opposed to having to re-render the entire page server-side with the FreeMarker template. Thus, client-side JavaScript changes and options may be generated from Dust templates, or from Backbone operations that bind Dust templates to the view being populated in the content div.

SASS functional component, used to process generated SASS code (e.g., scss, .css files, which provides page-specific CSS elements of the customer-facing page).

Scenario component, used to process generated data scenarios (e.g., .json files) that provide dummy data and define the data contract with the elements of the page. Different JSON files may be deployed for different scenarios in a web page. JSON files can be passed to FreeMarker or directly to a Model or Collection. For example, JSON files may be provided from a backend data design team in a structured way to be utilized by the front-end design team.

Test component, used to process generated tests (e.g., unit test scripts and browser automation test scripts (such as selenium test scripts)).

Imaging component, used to process generated images (e.g., .png, .jpeg/jpg, .gif images), including page-specific images.

In a further example, modules such as the module 520 serve as the primary reconfigurable components of the web page output, and are used to extend HTML-based templates (e.g., FreeMarker templates), and other defined characteristics for a particular web page presentation layer. For example, a hierarchy of modules which implement templates may be established for deployment of uniform web page code. The presentation layer SDK enables these templates and modules, representing stubbed-UI elements, to be easily changed and incorporated into web pages. In further examples, various modules may be directly mocked up and rendered in the presentation layer SDK, enabling design changes to the modules without requiring deployment of the modules in the web site. Accordingly, design teams can preview live components on a variety of platforms (including mobile device platforms) with simulated data sets.

### Example Operations of Presentation Layer SDK

A graphical user interface of a presentation layer development environment may provide verification of operation requirements during software installation according to an example described herein. For example, the presentation layer SDK may run a series of verifications to ensure installation or access to development, testing, and runtime components. In one example, these components may include, but are not limited to, Node.js, Java, Ruby, RubyGems, and Sass.

FIG. 6 illustrates a graphical user interface 600 of a presentation layer development environment providing a selection and modification of designed web pages according to an example described herein. The graphical user interface 600 includes a listing of various web pages and web page modules, including changeable and substitutable content within the modules. For example, pricing content for an e-commerce website may take one of many forms, based on changing data values. The graphical user interface 600 may provide the ability to view and render a particular web page module to visualize the use of the specific pricing content in a modular UI feature as presented and output by the use of respective pricing display modules.

Options for development in the graphical user interface 600 include options to “Compile”, “Test”, “Validate”, and the like. In some examples, the presentation layer development key may be configured to rebuild an HTML output (or an HTML preview) in real time as the web page is changed. Further, through compilation, testing, and validation, respective modules for web pages can be changed and previewed in real time. The compile process for HTML pages may include performance of optimization, error checking, and verification for errors (such as JavaScript errors). Technical optimizations, minifications, and tweaks can all be applied to the web page output to make the web page production ready. Further, the compilation, testing, and validation process can enforce quality standards for a particular web site, even while prototyping individually operating modules of the site.

In the graphical user interface 600, sample data elements may be used and defined by the presentation layer development environment. The correct data elements from production data sources may be obtained at a later time, with values such as names, prices, and other dynamic content being simulated during development of the web page components. Thus, the graphical user interface 600 can provide a replicated presentation of data and end-customer experience, relying on data aggregator definitions to tie the correct data to the components.

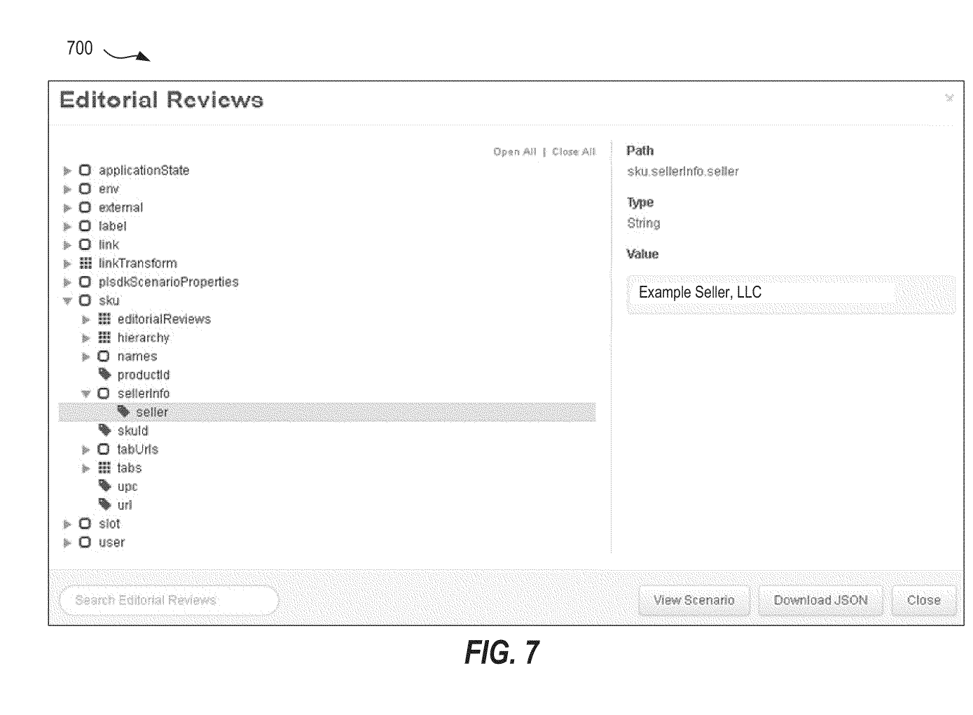

FIG. 7 illustrates a graphical user interface 700 of a presentation layer development environment providing a selection and modification of a data scenario used in a web page according to an example described herein. The data scenario illustrated, here titled “Editorial Reviews”, serves as a data structure having a variety of data types and data values. Such data scenarios are created through use of a data contract accessible by the presentation layer development environment, which ensures that the web page should look as it is supposed to when the actual data set is generated. The presentation layer development environment enables a developer to redo and change the format of presentation, as long as references to the data scenario remain the same.

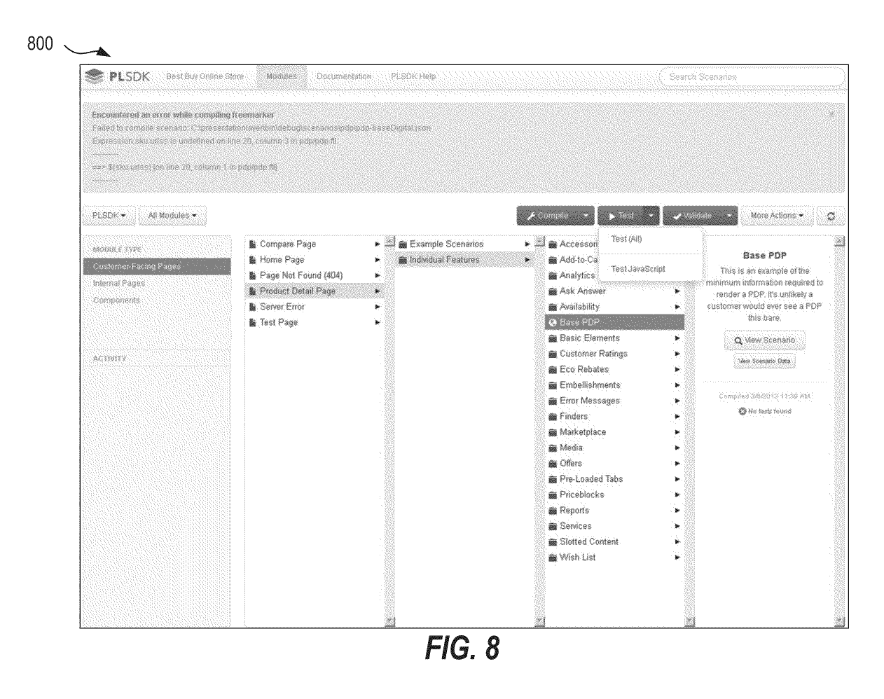

FIG. 8 illustrates a graphical user interface 800 of a presentation layer development environment providing a compilation and testing of designed web pages according to an example described herein. As shown in the graphical user interface 800, a particular expression is undefined and has encountered an error. Further mechanisms to interact with test scripts and testing methods may be accessed through the graphical user interface 800.

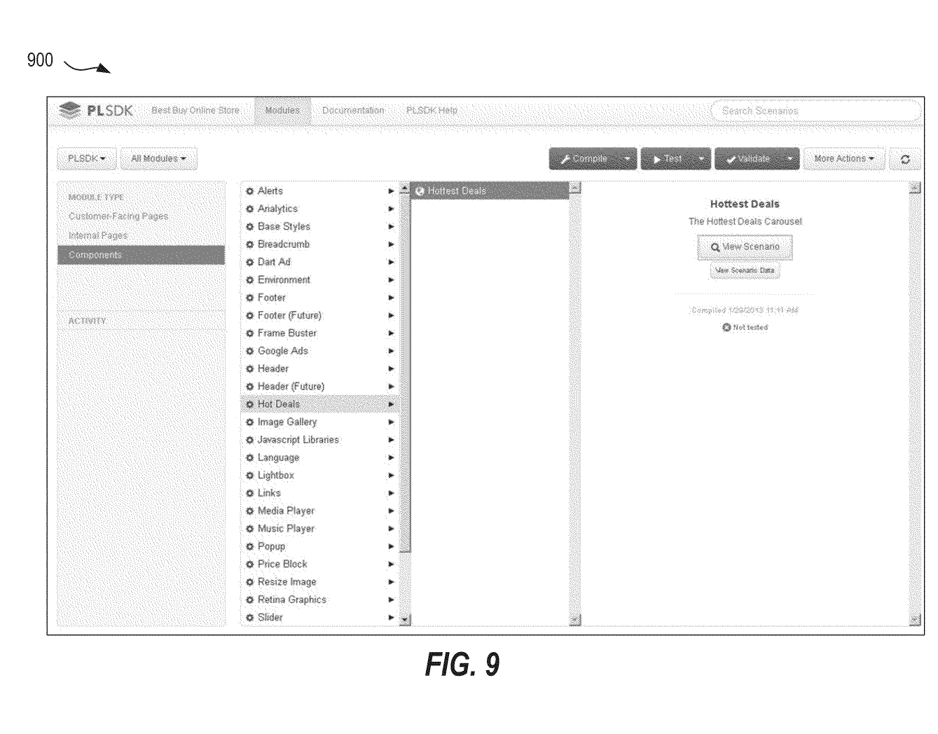

FIG. 9 illustrates a graphical user interface 900 of a presentation layer development environment providing another view for compilation and testing of modular components for use in a designed web page according to an example described herein. The graphical user interface 900 may provide a mechanism to view the web page component with a selected data scenario. Additionally, the graphical user interface 900 may provide an indication of compilation and testing. In further examples, runtime testing of the user interface may be performed to determine failure conditions of the modular components, templates, and rendered pages.

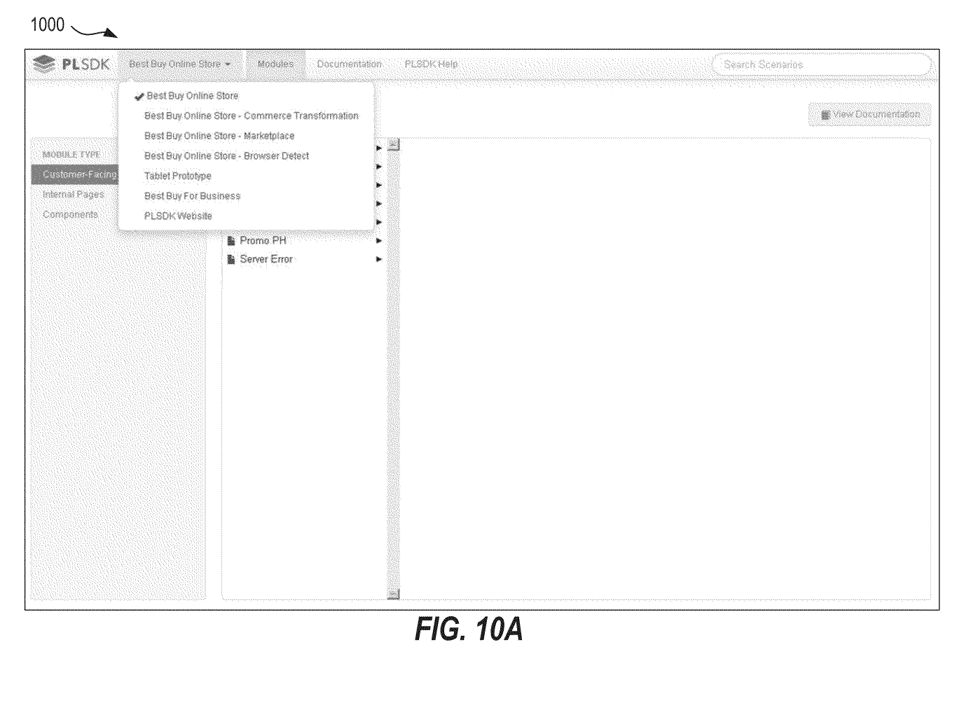

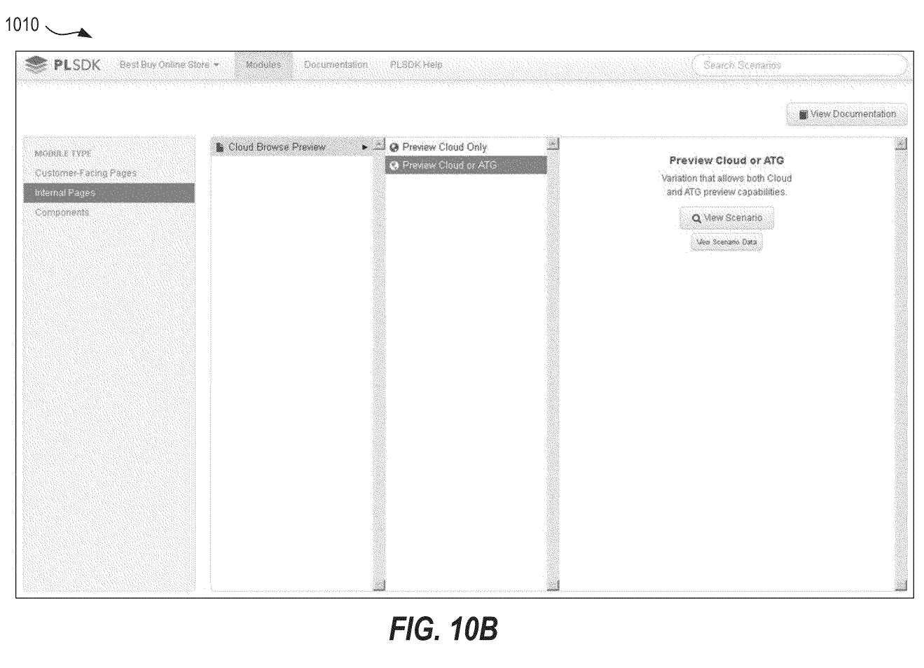

FIG. 10A illustrates a graphical user interface 1000 of a presentation layer development environment providing a selection of deployable web sites having designed web pages according to an example described herein. As shown in graphical user interface 1000, a variety of web site deployments may be selected from a pull-down menu. FIG. 10B illustrates a graphical user interface 1010 of a presentation layer development environment providing a preview of a deployable web site having designed web pages according to an example described herein. Not only are individual modules testable, but externally-visible and internally-visible pages may also be generated with use of the presentation layer development environment. Thus, the presentation layer SDK operates with more functionality than available from a simple development tool, it offers a various mechanisms to serve up portions of an entire webpage and website deployment project, and can provide display and testing functionality for a variety of stubbed-off UIs modules that are designed on a sample back-end.

Example Configurations and uses of the Presentation Layer SDK

In one further example, a variety of configuration properties and settings may be used in the presentation layer development environment. For example, configuration properties and values may define various values for a web site project in the presentation layer SDK. The presentation layer SDK can be used to maintain any number of web site projects. Each web site project can be individually configured to have unique details, configuration, deployment scripts, and help files. Thus, various options such as an identifier, name, version, source control branch, validation options, execution options, third party control options, and the like may be designated for each site designed by the presentation layer SDK.

In a further example, various third party components and data inputs may be deployed in the presentation layer SDK. Various folders and folder descriptions may be defined for use with the presentation layer SDK. The folders used by the presentation layer SDK may include: locations for inputs; locations of modules, templates, images, scripts, style sheets, and the like; locations for tests; and locations for help files.

In a further example, modules and module properties may be deployed in the presentation layer SDK. Modules are self-contained development elements that have individual HTML output, scripting, styles, and the like, which are used to provide a web page, component within a web page, or other display elements. The presentation layer SDK may be configured to accept a designation of a module and associated module properties, such as an identifier, display name, type, dependencies, help documentation, and the like, for use of the module in the presentation layer SDK.

In a further example, routes and route properties may be deployed in the presentation layer SDK. A route provides a mechanism to intercept requests and assisting data elements such as pages, images, scripts, and the like from a site's compiled artifacts. The presentation layer SDK may be configured to accept a designation of a route and associated route properties, such as a route array designating a method type, requests, responses, and any delay. The routing may be used to simulate server-side processing of some element, or to substitute a local/replacement copy of sample data from another data source.

In a further example, the routing may be implemented in connection with a proxy tool, which serves as an interface to an HTTP browser to intercept requests for data from a website address (e.g., a production website address), and offer a proxy server to satisfy these requests. The proxy tool may enable the presentation layer SDK to intercept requests for resources (such as HTML, .JS, .CSS files) and then request and return a local or sample copy of the resources. For example, the proxy tool may be configured to see if a request matches certain locations on a target server, from which the proxy will respond with local or substituted copies of the files. The interception of the request enables testing of a change as if it was located on a publicly accessible production site (e.g., website.com). The proxy tool may be configured to automatically perform routing within the presentation layer SDK interface during UI development. Further, the use of the proxy tool may be accompanied by testing elements, to operate a variety of tests on website update and changes that would otherwise not be fully tested on the production website.

In a further example, website templates and website template properties may be defined for use in the presentation layer SDK environment. A website template can serve as a file and folder structure for a set of web pages, and allows a web page to be created from a starting point with common content such as a standard header or footer. The presentation layer SDK may be configured to accept a designation of a template folder structure, and a designation of properties for commonly used files such as template, scripting, and style files.

In a further example, various APIs to the presentation layer SDK environment may be configured and exposed to provide an interface with other applications and tools. For example, a representational state transfer (REST) API may be exposed to the features and functions of the presentation layer SDK to provide interaction with other development and testing actions and programs.

### Computing System Architectures and Example Implementations

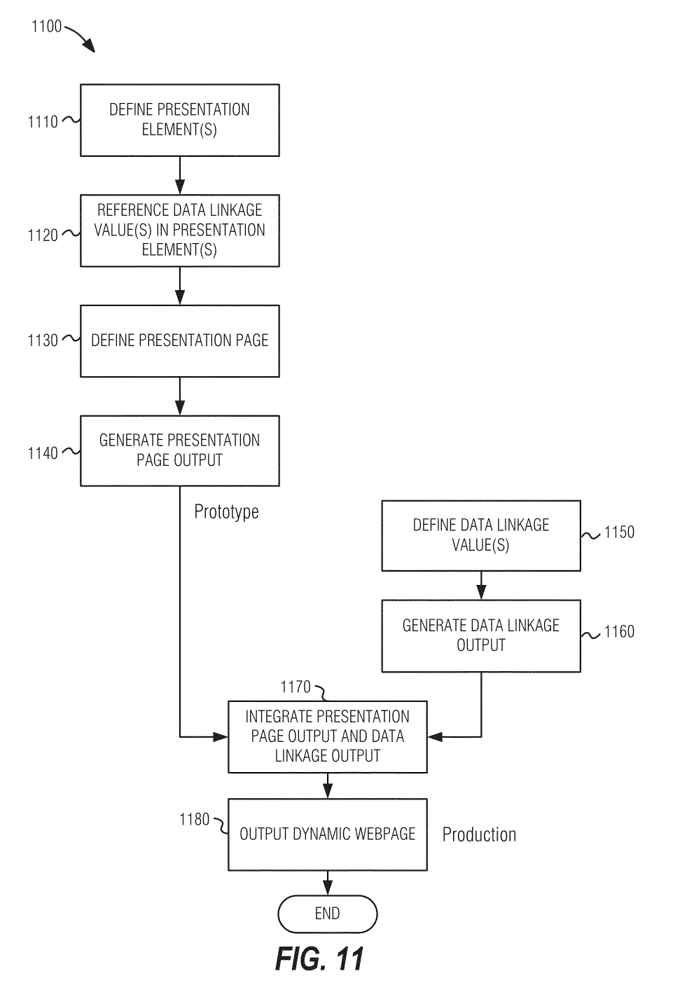

FIG. 11 illustrates a flowchart 1100 of an example workflow for generating a dynamic web page using the development framework and the presentation layer SDK according to an example described herein. The particular sequence depicted in the flowchart 1100 is provided as a non-limiting example, and illustrates a workflow involving the separate definition of presentation elements and data elements. It will be apparent that the order of development and integration with data elements may vary depending on the particular application, development lifecycle, and development scenario. In addition, other aspects of the workflow not illustrated may include additional interactions with information systems and associated graphical user interfaces.

The flowchart 1100 illustrates a series of operations executable with the presentation layer SDK, including the definition of presentation elements (operation 1110) and the creation of references to data linkage values in the presentation elements (operation 1120). The references to the data linkage values are used to define a presentation page (operation 1130), from which the presentation page output may be generated (operation 1140). During a prototype of the page, the data linkage values may be linked to dummy or test variables.

In parallel or separately, the actual data linkage values may be designated and integrated for use with the web page. This may include the definition of data linkage values (operation 1150) to replace the dummy or test variables used in the prototype page. This may also include a generation of a data linkage output (operation 1160) using the presentation layer SDK or other tools.

The presentation page output and the data linkage output is then integrated for serving from a website (operation 1170) such as from use of one or multiple web servers. From this integration on one or multiple web servers, an output of the dynamic web page content may be provided to client users (operation 1180).

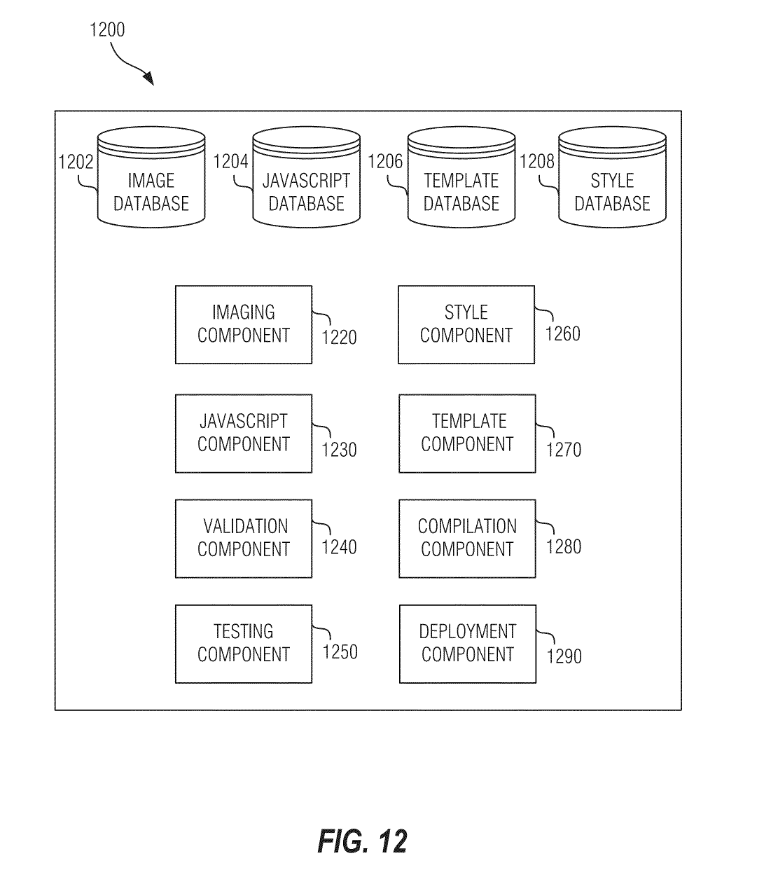

FIG. 12 illustrates an example configuration of a system architecture 1200 configured to implement the presently described presentation layer SDK and accompanying development framework. The system architecture 1200 may include an image database 1202, a JavaScript database 1204, a template database 1206, and a style database 1208. Functional components operating in the system architecture 1200 may include an imaging component 1220, a JavaScript component 1230, a validation component 1240, a testing component 1250, a style component 1260, a template component 1270, a compilation component 1280, and a deployment component 1290.

The image database 1202 may provide a location for storage of images used in connection with the operations of the presentation layer development environment. The JavaScript database 1204 may provide a location for storage of JavaScript files and related scripts used in connection with the operations of the presentation layer development environment. The template database 1206 may provide a location for storage of template files (e.g., FreeMarker files) and related template information used in connection with the operations of the presentation layer development environment. The style database 1208 may provide a location for storage of styles (e.g., CSS files) and related style information used in connection with the operations of the presentation layer development environment.

The respective components facilitate operations for developing web pages in the presentation layer development environment. For example, the imaging component 1220 may be used in connection with the image database 1202 to generate and modify images and image usage in the web page projects. The JavaScript component 1230 may be used in connection with the JavaScript database 1204 to generate and modify JavaScript and scripting usage in the web page projects. The style component 1260 may be used in connection with the style database 1208 to generate and modify cascading style sheets and other styles used in the web page projects. The template component 1270 may be used in connection with the template database 1206 to generate and modify templates and template output (e.g., FreeMarker template files) produced from the web page projects.

The other respective components facilitate development operations in the presentation layer development environment. The validation component 1240 may be used to perform validation of scripting and code syntax, and compliance with defined standards. The testing component 1250 may be used to test compliance with test scripts and output scenarios during or subsequent to validation of the scripting and code. The compilation component 1280 may be used to generate compilation of web pages and associated scripts and scripting languages. The deployment component 1290 may be used to generate a deployable version of the various image, scripting, template, and style files.

Although some of the previous examples were provided with reference to specific website applications (such as an e-commerce website), it will be understood that the applicability of the present system and methods may apply to a variety web sites and web application settings. Further, while the preceding examples provided reference to specific web-based presentation elements such as HTML code, JavaScript, and cascading style sheets, it will be apparent that the development techniques are also applicable to other presentation development environments and settings, including the development of software applications, mobile device interfaces, and the like. Further, other development and scripting languages other than HTML, JavaScript, and CSS may be used to implement the techniques and configurations described herein.

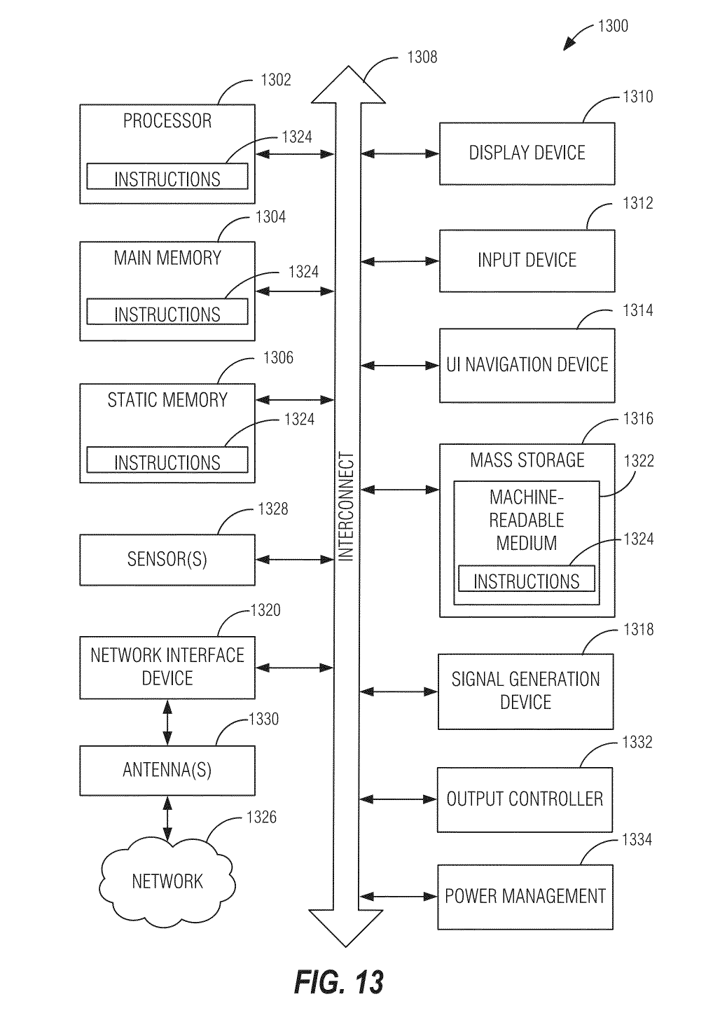

FIG. 13 is a block diagram illustrating an example computer system machine upon which any one or more of the methodologies herein discussed may be run. Computer system 1300 may be embodied as a computing device, providing operations of the components featured in FIG. 1A, including the presentation layer software development kit (SDK) and the associated computing device 102, the prototype environment 110, the production web servers and data sources 116, the client devices 122A, 122B, or any other processing or computing platform or component described or referred to herein. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The computer system machine may be a personal computer (PC) that may or may not be portable (e.g., a notebook or a netbook), a tablet, a set-top box (STB), a gaming console, a Personal Digital Assistant (PDA), a mobile telephone or smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 1300 includes a processor 1302 (e.g., a central processing unit (CPU), a graphics processing unit (GPU) or both), a main memory 1304 and a static memory 1306, which communicate with each other via an interconnect 1308 (e.g., a link, a bus, etc.). The computer system 1300 may further include a video display unit 1310, an alphanumeric input device 1312 (e.g., a keyboard), and a user interface (UI) navigation device 1314 (e.g., a mouse). In one embodiment, the video display unit 1310, input device 1312 and UI navigation device 1314 are a touch screen display. The computer system 1300 may additionally include a storage device 1316 (e.g., a drive unit), a signal generation device 1318 (e.g., a speaker), an output controller 1332, a power management controller 1334, and a network interface device 1320 (which may include or operably communicate with one or more antennas 1330, transceivers, or other wireless communications hardware), and one or more sensors 1328, such as a GPS sensor, compass, location sensor, accelerometer, or other sensor.

The storage device 1316 includes a machine-readable medium 1322 on which is stored one or more sets of data structures and instructions 1324 (e.g., software) embodying or utilized by any one or more of the methodologies or functions described herein. The instructions 1324 may also reside, completely or at least partially, within the main memory 1304, static memory 1306, and/or within the processor 1302 during execution thereof by the computer system 1300, with the main memory 1304, static memory 1306, and the processor 1302 also constituting machine-readable media.

While the machine-readable medium 1322 is illustrated in an example embodiment to be a single medium, the term “machine-readable medium” may include a single medium or multiple media (e.g., a centralized or distributed database, and/or associated caches and servers) that store the one or more instructions 1324. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, optical media, and magnetic media. Specific examples of machine-readable media include non-volatile memory, including, by way of example, semiconductor memory devices (e.g., Electrically Programmable Read-Only Memory (EPROM), Electrically Erasable Programmable Read-Only Memory (EEPROM)) and flash memory devices; magnetic disks such as internal hard disks and removable disks; magneto-optical disks; and CD-ROM and DVD-ROM disks.

The instructions 1324 may further be transmitted or received over a communications network 1326 using a transmission medium via the network interface device 1320 utilizing any one of a number of well-known transfer protocols (e.g., HTTP). Examples of communication networks include a local area network (LAN), wide area network (WAN), the Internet, mobile telephone networks, Plain Old Telephone (POTS) networks, and wireless data networks (e.g., Wi-Fi, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Other applicable network configurations may be included within the scope of the presently described communication networks. Although examples were provided with reference to a local area wireless network configuration and a wide area Internet network connection, it will be understood that communications may also be facilitated using any number of personal area networks, LANs, and WANs, using any combination of wired or wireless transmission mediums.

The embodiments described above may be implemented in one or a combination of hardware, firmware, and software. For example, the presentation layer SDK development environment may be client-operated software or be embodied on a server running an operating system with software running thereon. While some embodiments described herein illustrate only a single machine or device, the terms “system”, “machine”, or “device” shall also be taken to include any collection of machines or devices that individually or jointly execute a set (or multiple sets) of instructions to perform any one or more of the methodologies discussed herein.

Examples, as described herein, may include, or may operate on, logic or a number of components, modules, or mechanisms. Such components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium. In an example, the software, when executed by the underlying hardware of the component, causes the hardware to perform the specified operations.

Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the components need not be instantiated at any one moment in time. For example, where the component comprises a general-purpose hardware processor configured using software, the general-purpose hardware processor may be configured as respective different components at different times. Software may accordingly configure a hardware processor, for example, to constitute a particular component at one instance of time and to constitute a different component at a different instance of time.

Additional examples of the presently described method, system, and device embodiments include the following, non-limiting configurations. Each of the following non-limiting examples can stand on its own, or can be combined in any permutation or combination with any one or more of the other examples provided below, in the claims, or elsewhere in the present disclosure.

A first example can include the subject matter (such as an apparatus, a method, a means for performing acts, or a machine readable medium including instructions that, when performed by the machine, that can cause the machine to perform acts), for defining web page development with a presentation development system, including: defining, in the presentation development system, presentation elements of a web page; referencing data values in the presentation elements of the web page; defining the presentation elements of the web page in a template; and generating a web page output for serving by a web server using the template.

A second example can include, or can optionally be combined with the subject matter of the first example, to include subject matter (such as an apparatus, a method, a means for performing acts, or a machine readable medium including instructions that, when performed by the machine, that can cause the machine to perform acts), for a web page development system, including: a processor and a memory; a validation component executing with operations of the processor and the memory and configured to validate code of a designed web page, the web page including a plurality of designed web page components; a compilation component executing with operations of the processor and the memory and configured to generate compilation of the web page and scripts associated with the web page; a testing component executing with operations of the processor and the memory and configured to test the web page and the scripts associated with the web page for compliance with one or more tests; and a deployment component executing with operations of the processor and the memory and configured to deploy the web page with a template-based output.

A third example can include, or can optionally be combined with the subject matter of one or any combination of the first and second example, to include subject matter (such as an apparatus, a method, a means for performing acts, or a machine readable medium including instructions that, when performed by the machine, that can cause the machine to perform acts), for operations to: display a graphical user interface for defining a layout of a web page; assemble web page code for the layout of the web page; test the web page code; optimize the web page code; preview the web page code; and deploy the web page code as a template.

The following claims are hereby incorporated into the detailed description, with each claim and identified combination of claims standing on its own as a separate example.

What is claimed is:

1. A method for web page development with a presentation layer development system, comprising operations performed with software instructions of a presentation layer development system operating in a processor, the operations including:
defining a presentation layer of a web page using a presentation layer development system, the presentation layer including web page presentation components including an HTML template, wherein the HTML template includes references to a plurality of data values based on a data service contract;
processing the presentation layer of the web page using the presentation layer development system, the presentation layer being processed to build, test, and optimize the web page presentation components of the presentation layer; and
generating artifacts of the web page using the presentation layer development system, the artifacts being created from the web page presentation components and being structured for deployment of the presentation layer on a web server, wherein the artifacts are further structured for inclusion of rendered content from the web page presentation components in a modular portion of a web page within the web server.

2. The method of claim 1, wherein the data service contract is configured to define the plurality of data values, wherein the data service contract is fulfilled in the presentation layer development system with prototype data values, and wherein the data service contract is fulfilled in the web server with production data values.

3. The method of claim 1, wherein the artifacts include FreeMarker template files, wherein the HTML template is a FreeMarker template, wherein the web server operates to process the FreeMarker template to produce data for the data service contract from a production data source in response to deployment onto the web server.

4. The method of claim 3, wherein the data service contract is defined by a JavaScript Object Notation (JSON) object, wherein the presentation layer development system is configured to render the HTML template and associated JavaScript using the JSON object to mock up a server-side presentation with prototype data values.

5. The method of claim 1, wherein the presentation layer development system includes a site router and a preview component, the preview component configured to provide a preview of the presentation layer with deployment of the web server, the preview of the presentation layer using the site router, the site router operating as a proxy server and configured to intercept requests to a production web server and respond with responses from a prototype web server.

6. The method of claim 1, wherein the presentation layer development system includes a plurality of plug-in components configured to perform the processing of the presentation layer of the web page, the plurality of plug-in components configured to perform respective operations on the web page presentation components.

7. The method of claim 1, wherein the presentation layer development system is configured to test the presentation layer by performing a plurality of tests on the web page presentation components of the presentation layer, the plurality of tests including a unit test script and a browser automation test script.

8. The method of claim 1, wherein the presentation layer development system is configured to designate a plurality of modules for inclusion on the web page within the web server, wherein each of the plurality of modules is separately processed to build, test, and optimize additional web page presentation components of the presentation layer.

9. A non-transitory machine-readable storage medium comprising a plurality of instructions that, in response to being executed on a computing device, cause the computing device to:
define a presentation layer of a web page, the presentation layer including web page presentation components including an HTML template, a JavaScript, and a style sheet element, wherein the HTML template includes references to a plurality of data values based on a data service contract;
process the presentation layer of the web page, the presentation layer being processed to build, test, and optimize the web page presentation components of the presentation layer; and
generate artifacts of the web page, the artifacts being created from the web page presentation components and structured for deployment of the presentation layer on a web server, wherein the artifacts are further structured for inclusion of rendered content from the web page presentation components in a modular portion of a web page within the web server.

10. The machine-readable storage medium of claim 9, wherein the HTML template provides information to generate HTML output of a web page on a web server, and wherein the HTML template provides reference to one or more data objects with values of the one or more data objects included in the HTML, the values of the one or more data objects placed in the web page during generation of the HTML output of the web page.

11. The machine-readable storage medium of claim 9, wherein the data service contract is configured to define plurality of data values, wherein the data service contract is fulfilled during development of the presentation layer with prototype data values, and wherein the data service contract is fulfilled in the web server with production data values.

12. The machine-readable storage medium of claim 9, wherein the artifacts include FreeMarker template files, wherein the HTML template is a FreeMarker template, wherein the web server operates to process the FreeMarker template to produce data for the data service contract from a production data source upon deployment onto the web server.

13. The machine-readable storage medium of claim 12, the plurality of instructions further causing the computing device to:
render the HTML template and associated JavaScript against a JavaScript Object Notation (JSON) file to mock up server-side variations of data values, wherein the data service contract is defined by the JSON file.

14. The machine-readable storage medium of claim 9, the plurality of instructions further causing the computing device to:
preview of the presentation layer on deployment of the web server, the preview using a site router that is operating as a proxy server, the site router configured to intercept requests to a production web server to respond with responses from a prototype web server.

15. The machine-readable storage medium of claim 9, the plurality of instructions further causing the computing device to:
deploy a plurality of plug-in components to perform the processing of the presentation layer of the web page, the plurality of plug-in components configured to perform respective operations on the web page presentation components.

16. The machine-readable storage medium of claim 9, the plurality of instructions further causing the computing device to:
test the presentation layer by performing a plurality of tests on the web page presentation components of the presentation layer, the plurality of tests including a unit test script and a browser automation test script.

17. A web page development system, comprising:
a processor and a memory;
a presentation layer development system executing with operations of the processor and the memory, the presentation layer development system configured to define and process a presentation layer of a web page, the presentation layer including web page presentation components including an HTML template, a JavaScript script, and a style sheet element, wherein the HTML template includes references to a plurality of data values based on a data service contract;
a validation component executing with operations of the processor, the memory, and the presentation layer development system, the validation component configured to validate code of the HTML template, the JavaScript script, and the style sheet element;
a testing component executing with operations of the processor, the memory, and the presentation layer development system, the testing component configured to test an output of the web page presentation components with a unit test script or a browser automation test script, the test of the output of the web page presentation components performed using prototype data values provided according to the data service contract; and
a compilation component executing with operations of the processor, the memory, and the presentation layer development system, the compilation component configured to generate artifacts of the web page, the artifacts being created from the web page presentation components and structured for deployment of the presentation layer on a web server, wherein the artifacts are further structured for inclusion of content rendered from the web page presentation components in a modular portion of the web page within the web server.

18. The web page development system of claim 17, further comprising:
an imaging component executing with operations of the processor, the memory, and the presentation layer development system, the imaging component configured to implement an image used in the web page presentation components;
a JavaScript component executing with operations of the processor, the memory, and the presentation layer development system, the JavaScript component configured to implement the JavaScript script used in the web page presentation components;
a style component executing with operations of the processor, the memory, the presentation layer development system, the style component configured to implement the style sheet element used in the web page presentation components; and
a template component executing with operations of the processor, the memory, and the presentation layer development system, the template component configured to implement the HTML template used in the web page presentation components, wherein the artifacts created by the compilation component include a FreeMarker template file.

19. The web page development system of claim 18, further comprising:
a deployment component executing with operations of the processor, the memory, and the presentation layer development system, the deployment component configured to deploy the web page by rendering the FreeMarker template file on the web server;
wherein the web server operates to process the FreeMarker template file to produce data according to the data service contract from a production data source in response to deployment onto the web server.

20. The web page development system of claim 18, further comprising:
an image database configured to provide storage of the image;
a JavaScript database configured to provide storage of the JavaScript script;
a template database configured to provide storage of the HTML template; and
a style database configured to provide storage of the style sheet element.
